(19) United States
(12) Patent Application Publication
(10) Pub. No.: US 2009/0224604 A1
(43) Pub. Date: Sep. 10, 2009

(54) Semiconductor device having plural power source terminals coupled to function block and method of controlling the same

(75) Inventor: Toshihisa Koretsune, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/379,989

(22) Filed: Mar. 5, 2009

(30) Foreign Application Priority Data
Mar. 10, 2008 (JP) 2008-059817

(51) Int. Cl. H02J 1/10

(52) U.S. Cl. 307/43

(57) ABSTRACT

A semiconductor device includes at least one functional block, a plurality of power supply terminals for supplying a power to the functional block, and a plurality of switches each for controlling opening and closing of an electric connection between the each power supply terminal and the functional block individually. The plurality of power supply terminals are only connected with one another via the functional block, and each of the switches is electrically connected only with one power supply terminal among the plurality of power supply terminals.

### BACKGROUND OF THE INVENTION

1. Field of the Invention

The present invention relates to a semiconductor device and a method of controlling it, and more specifically, to a semiconductor device suited to an electric connection test with respect to power supplying.

2. Description of Related Art

Usually, a functional block is built in the semiconductor device and the functional block is electrically connected with a plurality of external terminals of the semiconductor device. Moreover, some functional blocks use dedicated power supplies in order to make small influence of noises from a semiconductor chip, etc. and further there exists a functional block having a plurality of dedicated power supplies in order to strengthen a power supplying capability.

On the other hand, there are some semiconductor devices each of which is equipped with a power supply switch in its functional block in order to attain lower power consumption. That is, when operating the functional block, the power supply switch is set to a state of closing to create a state of being able to supply power from the power supply terminal. However, when not operating the functional block, the power supply switch is set to a state of opening to interrupt supplying power to the inside of the functional block, whereby power consumption in the functional block is suppressed.

Moreover, in the semiconductor device, as its evaluation test, a validation test of electric connection is being conducted to power supplying wires of the functional block. This test is conducted usually using an evaluation apparatus, such as a tester. For example, when testing a wafer, usually a prober is used. In this case, a probe needle is made to electrically connect an external power supply terminal (pad) of the semiconductor device and the validation test is conducted.

FIG. 9 and FIG. 10 show schematic plan views schematically showing a semiconductor device according to a related art. A semiconductor device 51 has a functional block 52, such as a macro, a power supply switch 53 exclusively used by the functional block 52, a plurality of power supply terminals 54a to 54d exclusively used by the functional block 52, and an internal power supply wire 56 that electrically connects the functional block 52 and the power supply terminals 54a to 54d. FIG. 9 shows the semiconductor device with the power supply switch 53 set to be “opened,” and FIG. 10 shows the semiconductor device with the power supply switch 53 set to be “closed.” In the semiconductor device 51, the power supply terminals 54a to 54d are electrically connected with one another via the internal power supply wire 56. That is, the power supply terminals 54a to 54d are in a state of being short-circuited in the semiconductor device 51.

Incidentally, any wires electrically connected with the power supply are shown by thick lines and wires not electrically connected with the power supply are shown by thin lines in each diagram. Moreover, the power supply terminals electrically connected with the power supply are given hatching of a check (grating) pattern, and the power supply terminals not electrically connected with the power supply are given hatching of a stripe (oblique line) pattern. The power supply terminals and signal terminals that do not participate in the explanation of the present invention are not given hatching.

Here, in the semiconductor device 51, when operating the functional block 52, the power supply switch 53 is set to be “closed,” so that the functional block can be supplied power from the power supply terminals 54a to 54d. On the other hand, when not operating the functional block 52, the power consumption in the functional block 52 is suppressed by setting the power supply switch 53 to be “opened,” as shown in FIG. 9, and thereby interrupting supplying power to the functional block 52 from the power supply terminals 54a to 54d.

Patent Document 1 (Japanese Patent Application Laid open No. 2001-060653) discloses a test workable semiconductor integrated circuit for conducting the electric connection test between the power supply terminals of the semiconductor chip and the power supply terminals of a semiconductor package wire-bonded thereto. This test workable semiconductor integrated circuit builds therein a non-relay type testing switch that intervenes between the plurality of power supply terminals of the semiconductor package and the semiconductor chip and whose opening and closing are controllable by means of a terminal outside the semiconductor chip. By this incorporation, at the time of a normal operation, the functional blocks in the semiconductor chip are electrically connected with the plurality of power supply terminals of the semiconductor package, and at the time of the testing, the functional blocks are connected only with a predetermined power supply terminal of the semiconductor package. Moreover, as one form of the test workable semiconductor integrated circuit, a form in which the number of power supply terminals and the number of the functional blocks are different from each other and that has switches for electrically isolating the power supply terminals and switches for electrically isolating the functional blocks for every functional block is also disclosed.

### SUMMARY

The following analysis is given from a viewpoint of the present invention.

FIG. 11 is a schematic plan view schematically showing a semiconductor device according to a background art, and shows a semiconductor device in which a tester 57 for evaluating the electric connection of power supplying wires to the functional block 52 is electrically connected with the power supply terminals 54a to 54d of the semiconductor device 51 according to the background art shown in FIG. 9 and FIG. 10.

In the case of the semiconductor device 51 having a configuration as is shown in FIG. 9 to FIG. 11, since the power supply terminals 54a to 54d are electrically connected with one another by the internal power supply wire 56, if even one power supply terminal among the plurality of existing power supply terminals 54a to 54d is electrically connected with a probe needle of the tester 57, the semiconductor device 51 will pass an electric connection test. For example, as shown in FIG. 11, even in the case where the probe needle of the tester 57 is not connected with the power supply terminal 54c, or even in the case where the internal power supply wire 56 is not electrically connected with the power supply terminal 54d, since the internal power supply wire 56 and the probe needle of the tester 57 are electrically connected with the power supply terminals 54a, 54b normally, the semiconductor device can pass the electric connection test.

In such a case, even if a comparison is made between semiconductor devices that passed the electric connection test, since the semiconductor device that is supplied power normally from all the power supply terminals 54a to 54d and the semiconductor device that is not normally supplied power at a part of power supply terminals, as shown in FIG. 11, have different numbers of power supply terminals that are electrically connected, a difference will occur in transient electric power serviceability, and consequently a difference will arise in the evaluation result. Therefore, high-reliability evaluation cannot be performed in the semiconductor device having a configuration as shown in FIG. 9 to FIG. 11.

A test workable semiconductor integrated circuit described in Patent Document 1 is for conducting an electric test of the power supply terminals of a semiconductor package (power supply terminals wire-bonded to the power supply terminals of a semiconductor chip), and the power supply terminals of the semiconductor device are short-circuited in the semiconductor device. Therefore, the test workable semiconductor integrated circuit described in Patent Document 1 is not one that is capable of conducting the electric connection test of each power supply terminal of the semiconductor chip. Especially, it is impossible for the circuit to conduct the electric connection test of the each power supply terminal in the semiconductor chip whose functional block is connected with a plurality of power supply terminals. Moreover, even if the semiconductor device has a form having a switch for electrically isolating the power supply terminals disclosed in Patent Document 1, one functional block can electrically connects a specific power supply terminal (for example, the first power supply terminal) among a plurality of power supply terminals (for example, assuming that they are the first power supply terminal and the second power terminal) connected with the functional block; if it is intended to be connected with other power supply terminal (for example, the second power supply terminal), it has no alternative but to electrically connect also with the specific power supply terminal (for example, the first power supply terminal).

By a first exemplary aspect of the present invention, a semiconductor device that has at least one functional block, the plurality of power supply terminals for supplying power to the functional block, and a plurality of switches each for controlling opening and closing of the electric connection between each power supply terminal and the functional block individually is provided. In the semiconductor device, the plurality of power supply terminals are not electrically connected with one another unless being intermediated by the functional block. Each switch is electrically connected only with one power supply terminal among the plurality of power supply terminals.

According to a second exemplary aspect of the present invention, a method for controlling a semiconductor device equipped with a plurality of power supply terminals and a functional block electrically connected with the plurality of power supply terminals via switches is provided. When controlling an operation of the functional block, opening and closing of the electric connections between the plurality of power supply terminals and the functional block are controlled simultaneously. When checking the electric connection for each power supply terminal, a predetermined power supply terminal whose electric connection is to be checked and the functional block are electrically connected, and at the same time both electric connections between the predetermined power supply terminal and the other power supply terminals and electric connections between the other power supply terminals and the functional block are interrupted.

According to the exemplary aspects of the present invention, the electric connection test of each of the power supply terminals can be conducted without affecting a normal operation of the functional block. This capability can suppress occurrence of a situation in which a power supplying capability becomes different among the semiconductor devices that passed the electric connection test, and can better reliability of the test.

### BRIEF DESCRIPTION OF THE DRAWINGS

The above and other exemplary aspects, advantages and features of the present invention will be more apparent from the following description of certain exemplary embodiments taken in conjunction with the accompanying drawings, in which:

FIG. 1 is a schematic plan view schematically showing a semiconductor device according to a first exemplary embodiment of the present invention;

FIG. 2 is a schematic plan view schematically showing the semiconductor device according to the first exemplary embodiment of the present invention;

FIG. 3 is a schematic plan view schematically showing the semiconductor device according to the first exemplary embodiment of the present invention;

FIG. 4 is a schematic plan view schematically showing the semiconductor device according to the first exemplary embodiment of the present invention;

FIG. 5 is a schematic plan view schematically showing the semiconductor device according to the first exemplary embodiment of the present invention;

FIG. 6 is a schematic plan view schematically showing the semiconductor device according to the first exemplary embodiment of the present invention;

FIG. 7 is a schematic plan view schematically showing a semiconductor device according to a second exemplary embodiment of the present invention;

FIG. 8 is a schematic plan view schematically showing the semiconductor device according to the second exemplary embodiment of the present invention;

FIG. 9 is a schematic plan view schematically showing a semiconductor device according to a related art;

FIG. 10 is a schematic plan view schematically showing the semiconductor device according to the related art; and

FIG. 11 is a schematic plan view schematically showing the semiconductor device according to the related art.

### DETAILED DESCRIPTION OF THE EXEMPLARY EMBODIMENTS

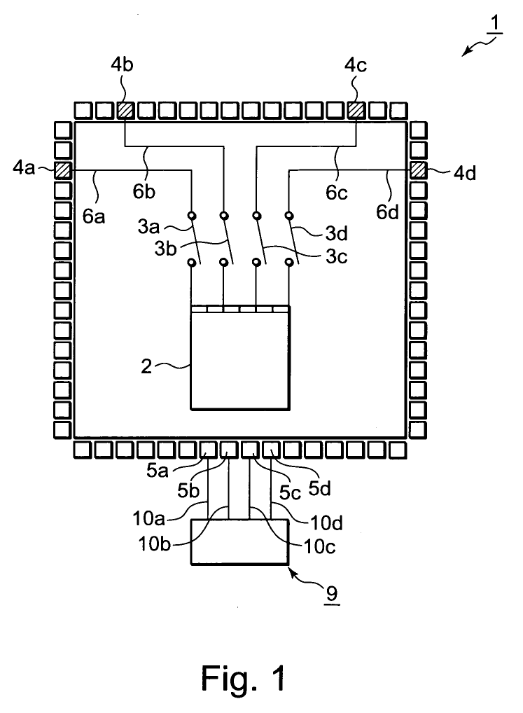

A semiconductor device according to a first exemplary embodiment of the present invention will be explained. FIG. 1 shows a schematic plan view schematically showing the semiconductor device according to the first exemplary embodiment of the present invention. A semiconductor device (semiconductor chip or package) 1 has at least one functional block 2, such as a macro, a plurality of power supply switches 3a to 3d exclusively used by the functional block 2, a plurality of power supply terminals (pads) 4a to 4d for the functional block 2, and internal power supply wires (in the circuit) 6a to 6d that connect at least one signal terminal (pad) 5a to 5d, the functional block 2, and at least one of the power supply terminals 4a to 4d.

Incidentally, each diagram illustrates only what is necessary for explanation of the present invention, and illustrations of any elements that are not used for the explanation (for example, a signal wire etc.) are omitted. Moreover, illustration of a situation of electric connections is as explained above.

The semiconductor device 1 is equipped with at least the power supply switches 3a to 3d whose number corresponds to the number of the power supply terminals 4a to 4d electrically connected with the functional block 2. The power supply switches 3a to 3d electrically connected with the functional block 2 are electrically connected with the power supply terminals 4a to 4d that correspond to the respective components via the internal power supply wires 6a to 6d. For example, the power supply switch 3a is connected between the functional block 2 and the power supply terminal 4a via the internal power supply wire 6a, the power supply switch 3b is connected between the functional block 2 and the power supply terminal 4b via the internal power supply wire 6b, the power supply switch 3c is connected between the functional block 2 and the power supply terminal 4c via the internal power supply wire 6c, and the power supply switch 3d is connected between the functional block 2 and the power supply terminal 4d via the internal power supply wire 6d.

Moreover, in the semiconductor device 1, the plurality of power supply terminals 4a to 4d are not electrically connected with one another unless being intermediated by the functional block 2. Similarly, the plurality of power supply switches 3a to 3d and the plurality of internal power supply wires 6a to 6d are not electrically connected with one another, respectively, either in the semiconductor device 1. That is, regarding electric connections between the power supply switches 3a to 3d and the power supply terminals 4a to 4d, they are electrically independent in the semiconductor device 1: the power supply switch 3a will be connected only with the power supply terminal 4a; the power supply switch 3b will be connected only with the power supply terminal 4b; the power supply switch 3c will be connected only with the power supply terminal 4c; and the power supply switch 3d will be connected only with the power supply terminal 4d, respectively.

As the power supply switches 3a to 3d, a switch made of transistors can be used, for example. Incidentally, it is natural that the numbers of the power supply switches and the terminals are not limited to the numbers shown in the figure and can be set up appropriately.

A selector 9 capable of individually controlling opening and closing of the power supply switches 3a to 3d from the outside is connected with the semiconductor device 1. For example, the selector 9 is electrically connected with the signal terminals 5a to 5d via external wires 10a to 10d.

Regarding the power supply switches 3a to 3d, the power supply switches 3a to 3d can be simultaneously opened and closed collectively by using a selector connected with the semiconductor device 1 or the like, and opening and closing of at least one power supply switch among the power supply switches 3a to 3d can also be controlled. Therefore, supplying power to the functional block 2 can be controlled by controlling opening and closing of all the power supply switches 3a to 3d, and the situation of electric connection of power supplying wires can also be checked by individually opening and closing the power supply switches 3a to 3d.

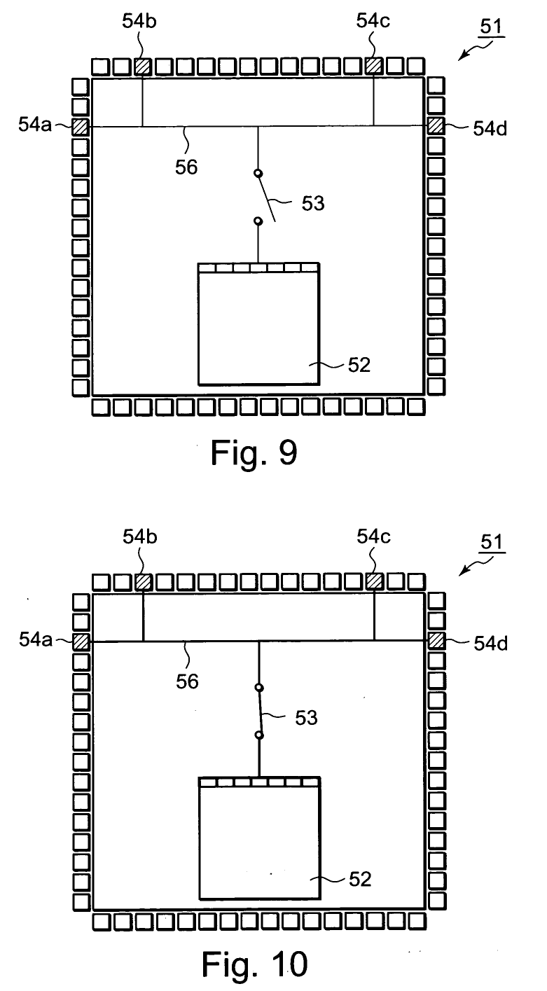

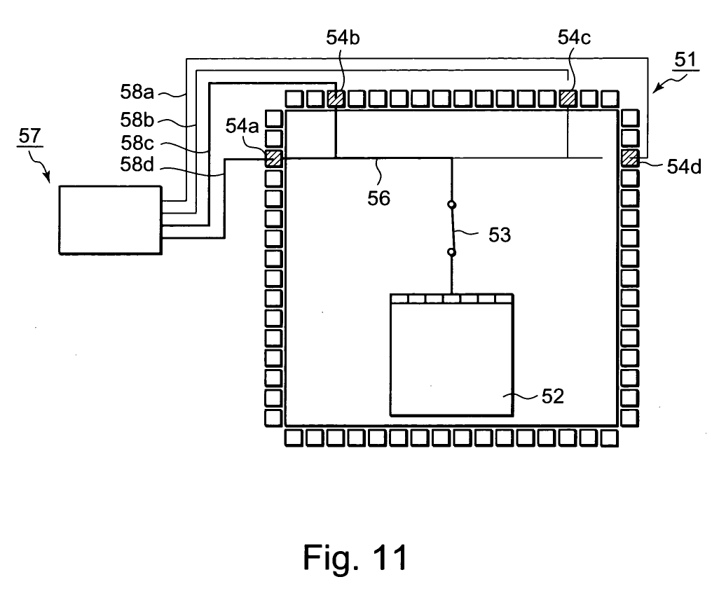

Moreover, in the case where transistors are used as the power supply switches 3a to 3d in the semiconductor device 1 of the present invention, since a total size of the power supply switches is allowed to be equivalent to that of a case where the power supply switch 1 as shown in FIG. 9 to FIG. 11 is unity, there is almost no increase in the area as compared with a form shown in FIG. 9 to FIG. 11.

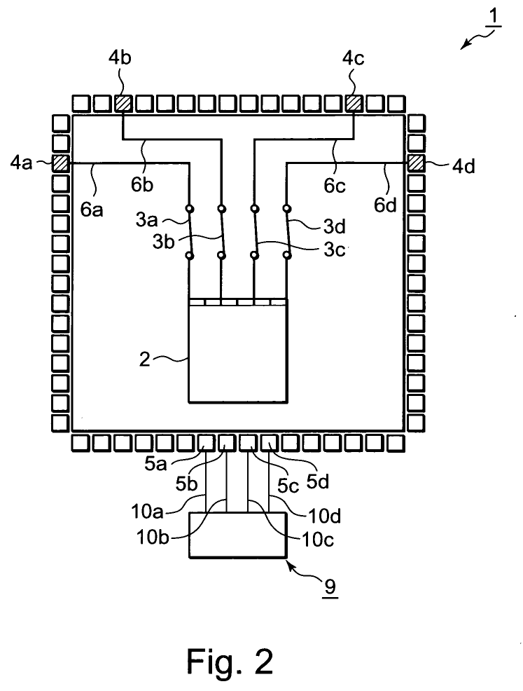

Next, a method for controlling the semiconductor device 1 of the present invention will be explained. FIG. 2 shows a schematic plan view schematically showing the semiconductor device according to the first exemplary embodiment of the present invention. FIG. 1 is a diagram showing a state in which the power supply switches 3a to 3d are all “opened,” and FIG. 2 is a diagram showing a state in which all the power supply switches 3a to 3d are “closed.”

First, a control method in controlling an operation of the functional block of the semiconductor device of the present invention will be explained. When operating the functional block 2 in the semiconductor device 1, the power supply switches 3a to 3d are all set to be “closed” by the selector 9, so that the functional block 2 and the power supply terminals 4a to 4d are all electrically connected together. On the other hand, when the functional block 2 is not operated, the power supply switches 3a to 3d are all set to be “opened,” so that the electric connections between the functional block 2 and the power supply terminals 4a to 4d are all interrupted. By this setting, supplying power to the functional block 2 can be controlled, and power consumption at the time of not using the functional block 2 can be suppressed.

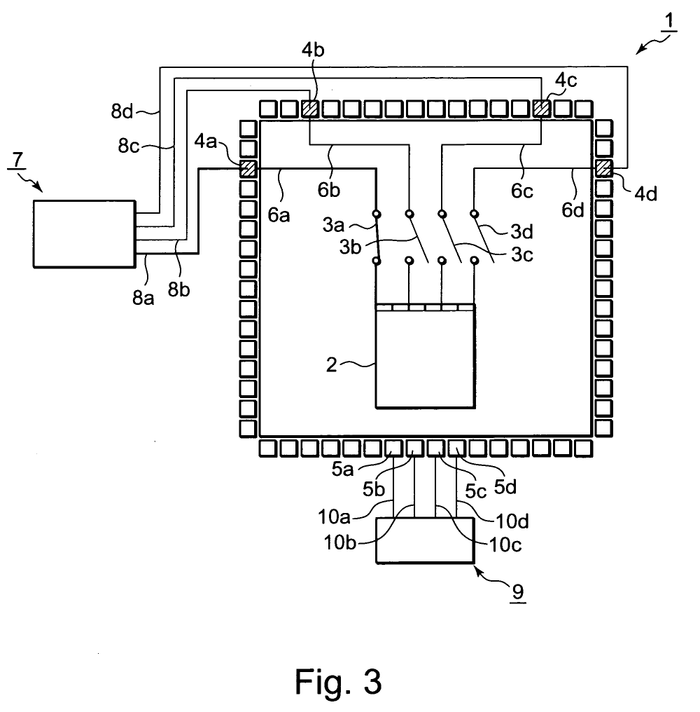

Next, the control method in an electric connection test of the semiconductor device of the present invention will be explained. FIG. 3 to FIG. 6 show schematic plan views schematically showing the semiconductor device according to the first exemplary embodiment of the present invention.

A tester 7 for evaluating the electric connections in the semiconductor device 1 is electrically connected with the power supply terminals 4a to 4d of the semiconductor device 1 via external wires 8a to 8d.

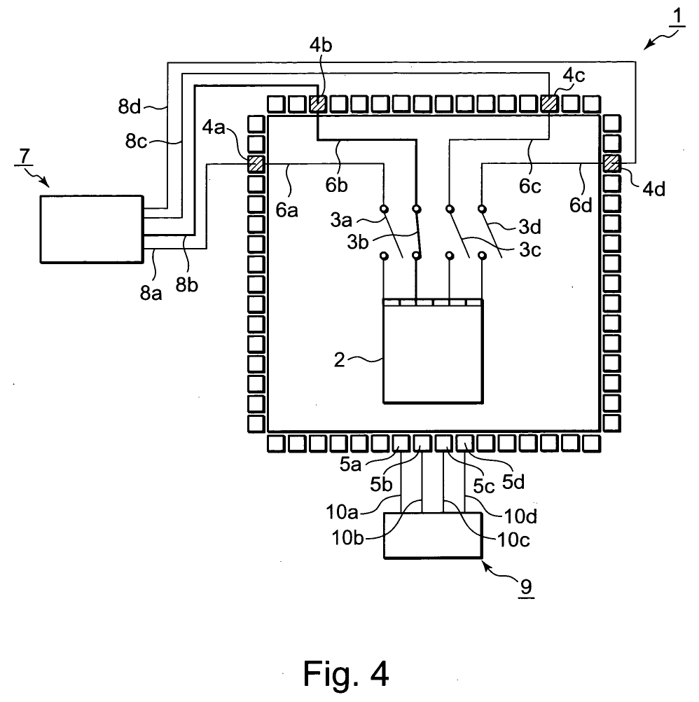

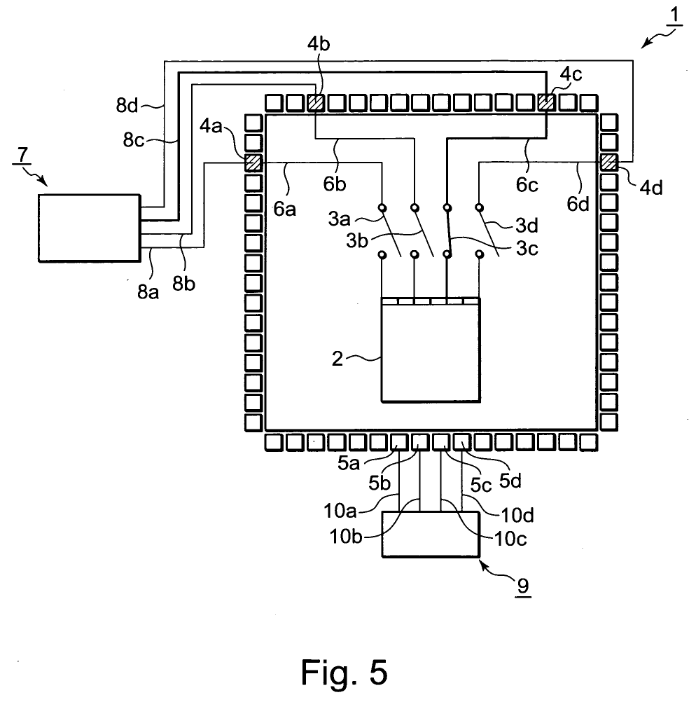

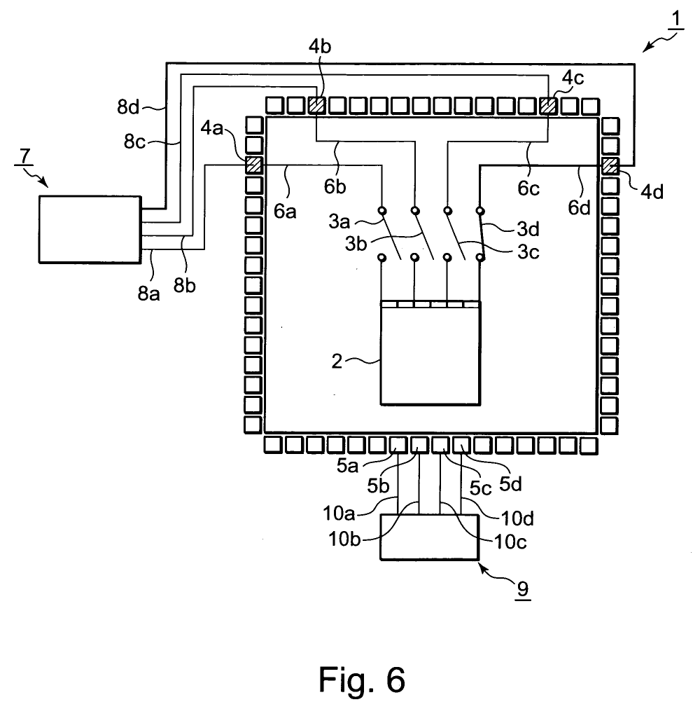

FIG. 3 shows a state in which only the power supply switch 3a among the power supply switches 3a to 3d is set to be “closed”. FIG. 4 shows a state in which only the power supply switch 3b among the power supply switches 3a to 3d is set to be “closed”. FIG. 5 shows a state in which only the power supply switch 3c among the power supply switches 3a to 3d is set to be “closed”. FIG. 6 shows a state in which only the power supply switch 3d among the power supply switches 3a to 3d is set to be “closed.” Thus, the power supply switches 3a to 3d and the internal power supply wires 6a to 6d that are electrically independent in the semiconductor device 1 are used and, with respect to a predetermined power supply terminal that will be checked for the electric connection, only the power supply switch connected with the predetermined power supply terminal is set to be “closed,” whereby it becomes possible for the predetermined power supply terminal and the functional block 2 to be electrically connected, and it becomes possible for both electric connections between the other power supply terminals and the functional block 2 and the electric connections between the predetermined power supply terminal and the other power supply terminals to be interrupted.

By this, the situations of electric connection in the power supplying wires (the power supply terminals 4a to 4d, the power supply switches 3a to 3d, and the internal power supply wires 6a to 6d) can be checked individually. Therefore, if there is a defect of no electric connection in any one of the wires etc., it can be checked surely. Moreover, it can suppress occurrence of a difference in a power supplying capability among the semiconductor devices that passed the test and can better reliability of the test.

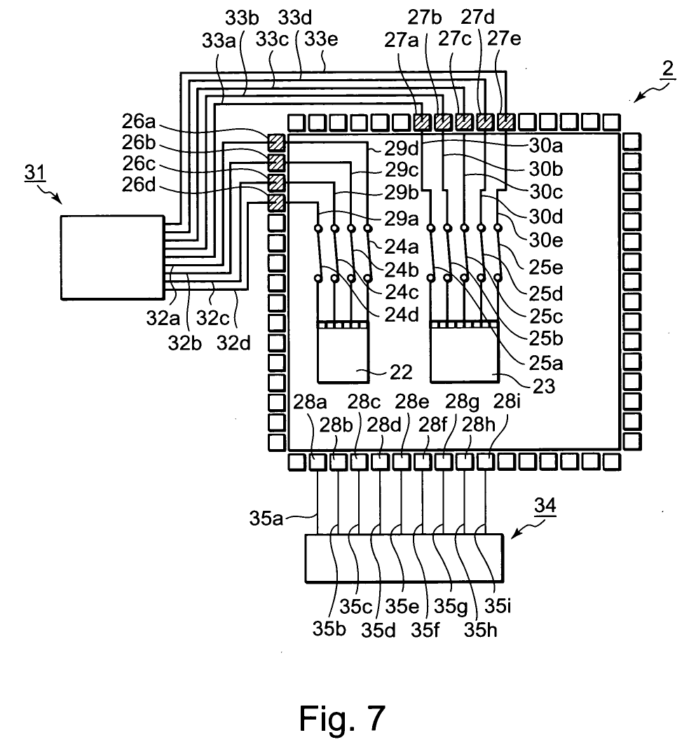

Next, a semiconductor device according to a second exemplary embodiment of the present invention will be explained. FIG. 7 shows a schematic plan view schematically showing the semiconductor device according to the second exemplary embodiment of the present invention. Although the semiconductor device having one functional block was explained in the first exemplary embodiment, in this exemplary embodiment the semiconductor device having a plurality of functional blocks will be explained. Incidentally, FIG. 7 shows a situation where a tester 31 for conducting the electric connection test is connected with a semiconductor device 21.

The semiconductor device 21 has a first functional block 22 and a second functional block 23. Moreover, the semiconductor device 21 has power supply switches 24a to 24d, 25a to 25e whose number corresponds to the number of first power supply terminals 26a to 26d electrically connected with the first functional block 22 and second power supply terminals 27a to 27e electrically connected with the second functional block 23. The first power supply switches 24a to 24d electrically connected with the first functional block 22 are electrically connected with the first power supply terminals 26a to 26d that correspond to the respective switches individually via first internal power supply wires 29a to 29d; the second power supply switches 25a to 25e electrically connected with the second functional block 23 are electrically connected with the second power supply terminals 27a to 27e that correspond to the respective switches individually via second power supply terminals 30a to 30e. Moreover, in this exemplary embodiment, the power supply wires are electrically independent in the semiconductor device 21, like the first exemplary embodiment.

In the semiconductor device 21, the selector 34 that enables opening and closing of the power supply switches 24a to 24d, 25a to 25e to be controlled individually from the outside is electrically connected with signal terminals 28a to 28i via external wires 35a to 35i.

The power supply switches 24a to 24d, 25a to 25e can also be simultaneously set to be opened and closed collectively by using a selector 34, and opening and closing of at least one arbitrary power supply switch among the power supply switches 24a to 24d, 25a to 25e can also be controlled. Therefore, supplying power to the first functional block 22 and the second functional block 23 can be controlled by controlling opening and closing of all of the first power supply switches 24a to 24d and the second power supply switches 25a to 25e. Moreover, if opening and closing of the power supply switches 24a to 24d or the power supply switches 25a to 25e are controlled for each functional block, the functional blocks 22, 23 can also be operated individually. Further, the situations of electric connection of the power supply wires can be checked by individually opening and closing the respective power supply switches 24a to 24d, 25a to 25e.

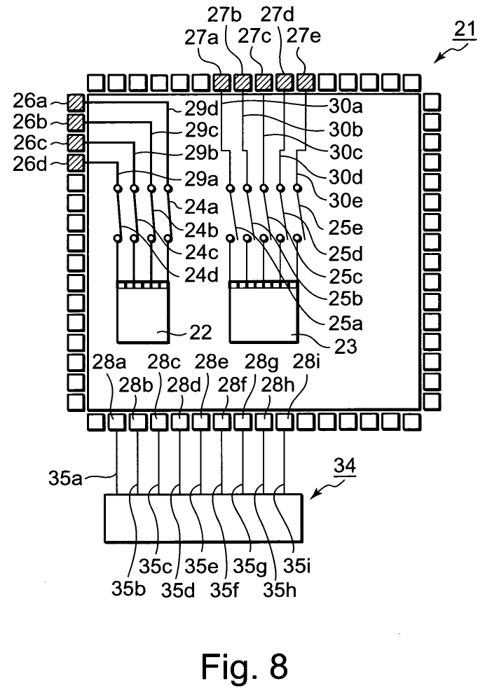

Next, a control method of the semiconductor device 21 according to the second exemplary embodiment of the present invention will be explained using FIG. 7 and FIG. 8. FIG. 7 is a diagram showing a state in which all the power supply switches 24a to 24d, 25a to 25e are set to be “closed.” FIG. 8 is a diagram showing a state in which the first power supply switches 24a to 24d are set to be “closed” and the second power supply switches 25a to 25e are set to be “opened.” When operating the first functional block 22, the first power supply switches 24a to 24d connected with the first functional block 22 are all set to be “closed” in the same manner as the first exemplary embodiment; when not operating the first functional block 22, the first power supply switches 24a to 24d are all set to be “opened.” Similarly, when operating the second functional block 23, the second power supply switches 25a to 25e are all set to be “closed”; when not operating the second functional block 23, the second power supply switches 25a to 25e are all set to be “opened.” Therefore, when simultaneously operating the first functional block 22 and the second functional block 23, the first power supply switches 24a to 24d and the second power supply switches 25a to 25e are all set to be “closed”; when not simultaneously operating the first functional block 22 and the second functional block 23, the first power supply switches 24a to 24d and the second power supply switches 25a to 25e are all set to be “opened.” Moreover, when operating at least one functional block among the plurality of functional blocks, for example, when operating only the first functional block 22 among the first functional block 22 and the second functional block 23, the first power supply switches 24a to 24d are set to be “closed” and the second power supply switches 25a to 25e are set to be “opened,” as shown in FIG. 8.

By doing this, supplying power to the first functional block 22 and the second functional block 23 can be controlled, and the power consumption when the first functional block 22 and the second functional block 23 are not used can be suppressed.

Next, a control method in the electric connection test of the semiconductor device according to the second exemplary embodiment of the present invention will be explained using FIG. 7. The tester 31 for evaluating the electric connections in the semiconductor device 21 is electrically connected with the first power supply terminals 26a to 26d and the second power supply terminals 27a to 27e of the semiconductor device 21 via first external wires 32a to 32d and second external wires 33a to 33e.

When conducting an electric connection evaluation test, like the first exemplary embodiment, only the power supply switch connected with the predetermined power supply terminal that will become a subject of the test is set to be “closed” and the other power supply switches than it are set to be “opened,” as shown in FIG. 3 to FIG. 6. By this, even in the case of the semiconductor device 21 equipped with a plurality of functional blocks 22, 23, the situations of electric connections of the respective power supplying wires can be checked individually.

### INDUSTRIAL APPLICABILITY

Although the semiconductor device of the present invention and a method for manufacturing it were explained based on the above-mentioned exemplary embodiments, it is natural that the above-mentioned exemplary embodiments may include various variants, alterations, and improvements within a range of the present invention and based on a basic technological thought of the present invention without being limited to the above-mentioned exemplary embodiments. Moreover, within a limit of the scope of claims of the present invention, versatile combinations, substitutions, or selections of the disclosed various elements are possible.

Further problems, objects, and developmental forms of the present invention will be made clear also from all disclosed matters of the present invention including the scope of claims.

Further, it is noted that Applicant's intent is to encompass equivalents of all claim elements, even if amended later during prosecution.

What is claimed is:

1. A semiconductor device, comprising:
at least one functional block;
a plurality of power supply terminals for supplying a power to the functional block; and
a plurality of switches each for controlling opening and closing of an electric connection between each power supply terminal and the functional block individually,
wherein the plurality of power supply terminals are only connected with one another via the functional block, and each of the switches is electrically connected only with one power supply terminal among the plurality of power supply terminals.

2. The semiconductor device according to claim 1, further comprising:
a plurality of functional blocks including the at least one functional block,
wherein each of the switches is controlled to be opened and closed for each of the functional blocks.

3. A method of controlling a semiconductor device, the semiconductor device comprising:
a plurality of power supply terminals;
a plurality of switches; and
a functional block being electrically connected with the plurality of power supply terminals via the plurality of switches,
the method comprising:
when controlling an operation of the functional block, opening and closing of electrical connections between the plurality of power supply terminals and the functional block simultaneously by all of the plurality of switches; and
when checking the electrical connection of each of the power supply terminals, electrically connecting a first power supply terminal among the plurality of power supply terminals to be checked for the electrical connection and the functional block, and interrupting an electrical connection between a second power supply terminal among the plurality of power supply terminals and the first power supply terminal, and further interrupting an electrical connection between the second power supply terminal and the functional block.

4. The method according to claim 3,
wherein the semiconductor device is equipped with a plurality of functional blocks including the functional block,
the method further comprising:
when controlling an operation of a predetermined functional block among the plurality of functional blocks, simultaneously controlling an electrical connection between the predetermined functional block and the plurality of power supply terminals electrically connected with the predetermined functional block.

5. A semiconductor device, comprising:
a plurality of external power supply terminals;
a plurality of conductive wirings connected to the plurality of external power supply terminals, respectively, the plurality of conductive wirings being electrically independent of each other;
a macro circuit as a function block including a plurality of internal terminals; and
a plurality of switch circuits provided between the plurality of external power supply terminals and the plurality of internal terminals, respectively.
